(19) United States
(12) Patent Application Publication
(10) Pub. No.: US 2025/0353543 A1
(43) Pub. Date: Nov. 20, 2025

(54) STEERING SYSTEM FOR USE IN TURNING STEERABLE VEHICLE WHEELS

(71) Applicant: ZF Active Safety and Electronics US LLC, Livonia, MI (US)

(72) Inventors: James Wang, Bloomfield Hills, MI (US); Ramesh Chirla, Troy, MI (US); Hanumantha Rao Dhulipalla, Rochester Hills, MI (US)

(21) Appl. No.: 18/665,731

(22) Filed: May 16, 2024

(51) Int. Cl. B62D 5/04

(52) U.S. Cl. CPC B62D 5/0442; B62D 5/0421

(57) ABSTRACT

A steering system includes an electric motor having a motor output shaft rotatable about a first axis. A first planetary gear stage is drivable via torque from the motor output shaft. A second planetary gear stage is drivable via torque from the first planetary gear stage. An output shaft is connected directly to the second planetary gear stage such that torque from the second planetary gear stage directly urges the output shaft to rotate about a second axis. The second axis being coaxial with or nonparallel to the first axis. A pitman arm is directly connected to the output shaft such that torque from the output shaft directly urges the pitman arm to rotate about the second axis. The pitman arm is connected to the steerable vehicle wheels via a steering linkage such that rotation of the pitman arm affects steering of the steerable vehicle wheels.

### TECHNICAL FIELD

The present invention relates to a steering system for use in turning steerable vehicle wheels.

### BACKGROUND OF THE INVENTION

Vehicle steering systems that include gearboxes and electric motors are known. In certain systems, the gearbox converts rotary motion from the electric motor to linear motion via a ball screw assembly. Eventually, this linear motion is converted back into rotary motion in order for an output shaft of the gearbox to rotate a pitman arm that is operatively connected to steerable vehicle wheels. Conversions such as these at least partially reduces system efficiency.

### SUMMARY OF THE INVENTION

According to an aspect of the invention, alone or in combination with any other aspect, a steering system for use in turning steerable vehicle wheels comprises an electric motor having a motor output shaft rotatable about a first axis. A first planetary gear stage is drivable via torque from the motor output shaft. A second planetary gear stage is drivable via torque from the first planetary gear stage. An output shaft is connected directly to the second planetary gear stage such that torque from the second planetary gear stage directly urges the output shaft to rotate about a second axis. The second axis being coaxial with or nonparallel to the first axis. A pitman arm is directly connected to the output shaft such that torque from the output shaft directly urges the pitman arm to rotate about the second axis. The pitman arm is connected to the steerable vehicle wheels via a steering linkage such that rotation of the pitman arm affects steering of the steerable vehicle wheels.

According to an aspect of the invention, alone or in combination with any other aspect, the steering system further comprises an intermediate shaft operatively between the first and second planetary gear stages. The intermediate shaft is connected to the first planetary gear stage and a steering wheel such that torque from each of the first planetary gear stage and the steering wheel urges the intermediate shaft to rotate about the second axis. The intermediate shaft is also connected to the second planetary gear stage such that torque from the intermediate shaft drives the second planetary gear stage.

According to an aspect of the invention, alone or in combination with any other aspect, the steering system further comprises an intermediate shaft operatively between the motor output shaft and the first planetary gear stage. The intermediate shaft is connected to the motor output shaft and a steering wheel such that torque from each of the motor output shaft and the steering wheel urges the intermediate shaft to rotate about the second axis. The intermediate shaft is also connected to the first planetary gear stage such that torque from the intermediate shaft drives the first planetary gear stage.

According to an aspect of the invention, alone or in combination with any other aspect, the output shaft is further connected to a steering wheel such that torque from the steering wheel also urges the output shaft to rotate about the output axis. A force flow from each of the electric motor and the steering wheel to the pitman arm is entirely torque-based with no torque-to-linear force transitions and no linear force-to-torque transitions.

According to an aspect of the invention, alone or in combination with any other aspect, a steering system for use in turning steerable vehicle wheels comprises a steering wheel and an electric motor. An intermediate shaft is connected to the motor output shaft and the steering wheel such that torque from each of the motor output shaft and the steering wheel urges the intermediate shaft to rotate about an axis. A first planetary gear stage is drivable via torque from the intermediate shaft. A second planetary gear stage is drivable via torque from the first planetary gear stage. An output shaft is connected directly to the second planetary gear stage such that torque from the second planetary gear stage directly urges the output shaft to rotate about the axis. A pitman arm is directly connected to the output shaft such that torque from the output shaft directly urges the pitman arm to rotate about the axis. The pitman arm is connected to the steerable vehicle wheels via a steering linkage such that rotation of the pitman arm affects steering of the steerable vehicle wheels.

According to an aspect of the invention, alone or in combination with any other aspect, the steering system is a steer-by-wire steering system with no mechanical connection between a steering wheel and the steerable vehicle wheels or convertible to a steer-by-wire steering system via removal of any mechanical connection between the steering wheel and the steerable vehicle wheels.

According to an aspect of the invention, alone or in combination with any other aspect, a force flow from the electric motor to the pitman arm and/or the steering wheel to the pitman arm is entirely torque-based with no torque-to-linear force transitions and no linear force-to-torque transitions.

### BRIEF DESCRIPTION OF THE DRAWINGS

The foregoing and other features and advantages of the present invention will become apparent to those skilled in the art to which the present invention relates upon reading the following description with reference to the accompanying drawings, in which:

FIG. 1 is a schematic illustration an example steering system for use in turning steerable vehicle wheels, including an EPS unit of the steering system in a first configuration;

FIG. 2 is a cross-sectional view of the EPS unit of FIG. 1;

FIG. 3 is an isolated view of a portion of the EPS unit of FIG. 1;

FIG. 4 is an isolated view of a portion of the EPS unit of FIG. 1;

FIG. 5 is an isolated view of a portion of the EPS unit of FIG. 1;

FIG. 6 is an isolated view of a portion of the EPS unit of FIG. 1;

FIG. 7 is a side view of another configuration of the EPS unit of FIG. 1;

FIG. 8 is a cross-sectional view of the EPS unit of FIG. 7;

FIG. 9 is an isolated view of a portion of the EPS unit of FIG. 7; and

FIG. 10 is an isolated view of a portion of the EPS unit of FIG. 7.

### DETAILED DESCRIPTION

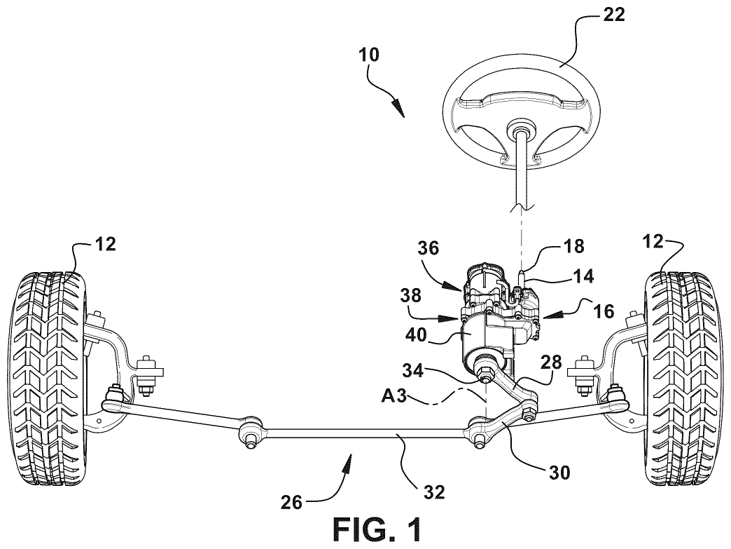

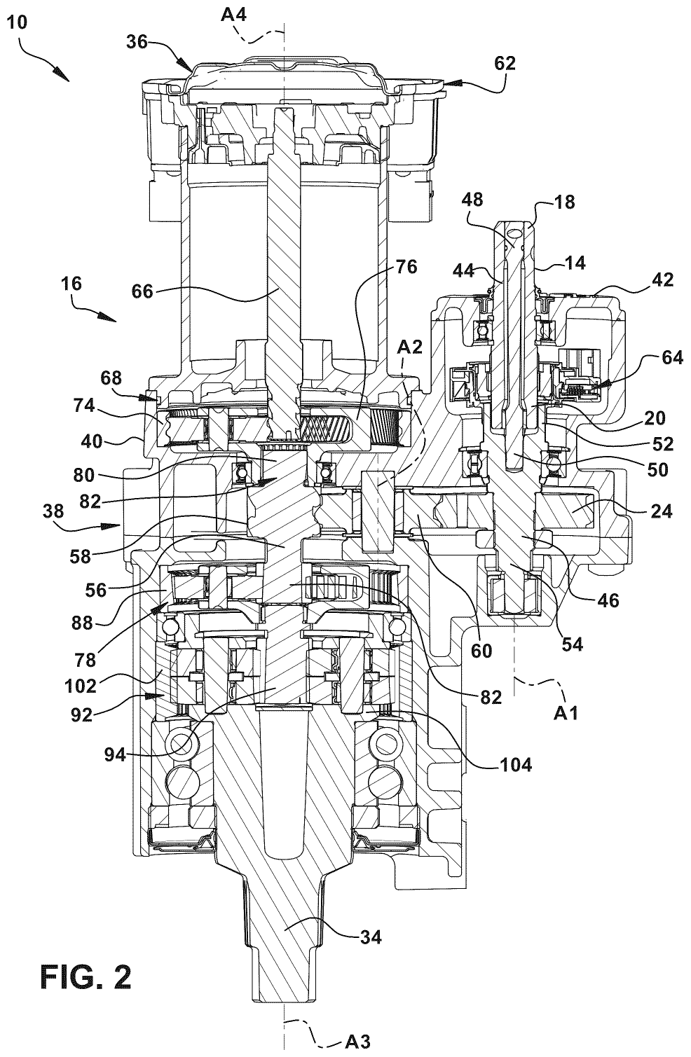

The present invention relates to a steering system for use in turning steerable vehicle wheels. An example steering system 10 for use in turning steerable vehicle wheels 12 is schematically illustrated in FIG. 1. The steering system 10 can be, e.g., used in a commercial vehicle. The steering system 10 includes an input shaft 14 and an electrically powered steering unit (“EPS unit”) 16 for providing steering assist. The input shaft 14 extends from a first end 18 to a second end 20 (FIG. 2). A steering wheel 22 is connected to the first end 18. For example, the steering wheel 22 may be connected to the first end 18 via a steering column, one or more shafts, one or more joints (e.g., universal joints), or any combination thereof. An input gear 24 (FIG. 2) is connected to or provided on the second end 20. Rotation of the steering wheel 22 transmits torque through the input shaft 14 to the input gear 24. In other words, the input gear 24 is urged to rotate under the influence of torque transmitted through the input shaft 14.

A pitman arm 28 has one end connected to an output shaft 34 of the EPS unit 16, and the other end connected to the steerable vehicle wheels 12 via a steering linkage 26. As shown, the steering linkage 26 includes first and second steering members 30, 32. The first steering member 30 is connected to the pitman arm 28 and can be, for example, a drag link. The second steering member 32 is connected to the first steering member 30 and at least one of the steerable wheels 12. The third steering member 32 can be, for example, a tie rod.

The EPS unit 16 provides steering assist by affecting movement of the pitman arm 28—and therefore the steerable wheels 12 via the steering linkage 26—in response to rotation of the steering wheel 22. Referring further to FIGS. 1-2, the EPS unit 16 includes an electric motor 36 (e.g., a reversible electric motor) and a gearbox 38 connected to the motor.

As shown in FIG. 2, the gearbox 38 has a housing 40 in which the input gear 24 is rotatably supported. The housing 40 may be formed as a single monolithic piece or assembled from separate subcomponents. A cap 42 is connected to the housing 40 and receives the input shaft 14 in a manner that allows for relative rotation therebetween. The first end 18 of the input shaft 14 may thus be external to the housing 40, while the second end 20 may be inside the housing 40. A torsion bar 44 and an output shaft 46 help transfer rotation of the second end 20 of the input shaft 14 to the input gear 24. The input shaft 14, the torsion bar 44, the output shaft 46 and input gear 24 may be coaxial with one another.

The torsion bar 44 extends within the input shaft 14 and the output shaft 46. A first end 48 of the torsion bar 44 is fixed for rotation with the input shaft 14, while a second end 50 of the torsion bar is fixed for rotation with the output shaft 46. When the input shaft 14 is rotated by the steering wheel 22, the torsion bar 44 permits a prescribed amount of relative rotation between the input shaft and the output shaft 46 before the input shaft and the output shaft rotate together.

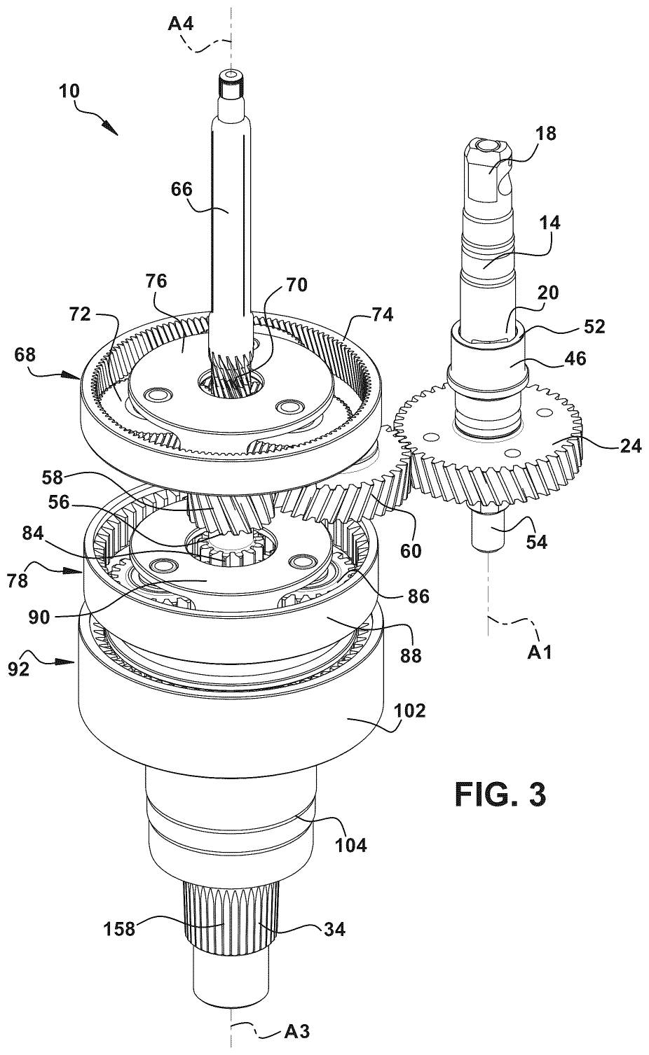

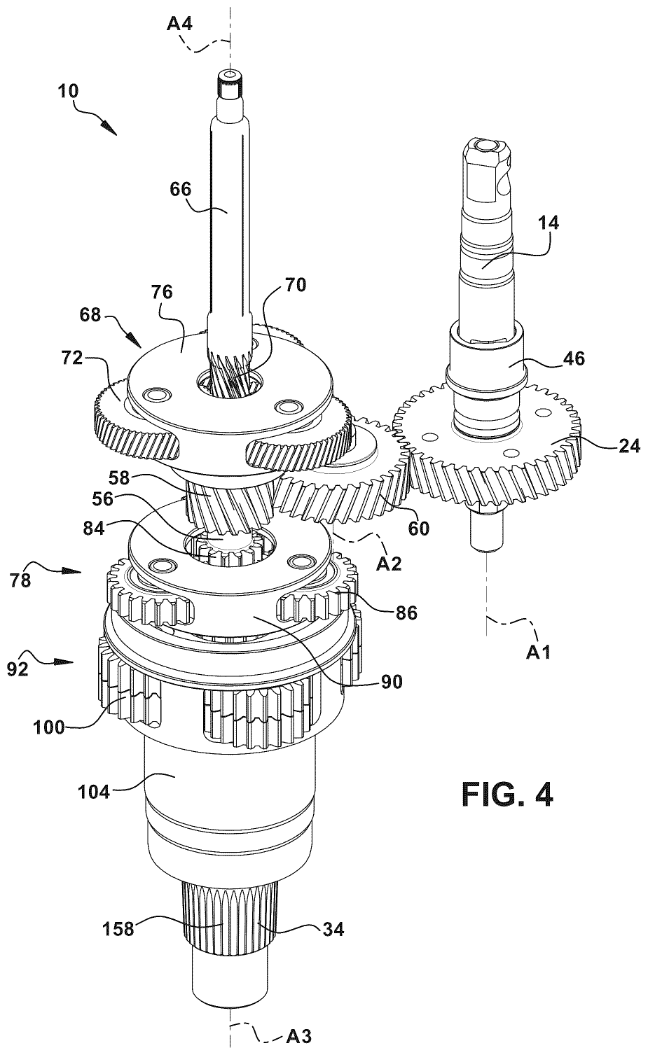

As shown in FIGS. 2-4, the output shaft 46 has a first end 52 in which the second end 20 of the input shaft 14 extends. A second end 54 of the output shaft 46 extends through and engages the input gear 24 in a rotationally fixed manner, though the input gear may be formed integrally with the output shaft 46 as a single monolithic piece. The input gear 24 thus is rotatable with the output shaft 46 about a first rotational axis A1 relative to the housing 40.

The input gear 24 may be operatively connected to an intermediate shaft 56 such that rotation of the input gear 24 responsively rotates or urges the intermediate shaft 56 to rotate relative to the housing 40. In particular, an output gear 58 is secured to and rotatable with the intermediate shaft 56. The output gear 58 is formed integrally with the intermediate shaft 56 as a single monolithic piece, though the output gear may be formed separately from and subsequently rotationally fixed to the intermediate shaft. An idler gear 60 is meshingly engaged to both the input gear 24 and the output gear 60 such that rotation of the input gear responsively rotates or urges the idler gear to rotate about a second rotational axis A2, which responsively rotates or urges the output gear and attached intermediate shaft 56 to rotate about a third rotational axis A3. Although each of the first, second, and third rotational axes A1, A2, A3 are shown as being parallel with and offset from one another, the steering system 10 may be configured such that at least one of these axes may be nonparallel with at least one other of these axes.

Each of the input gear 24, the output gear 58 and the idler gear 60 may be a helical gear or any other desired gear. A gear reduction ratio from the input gear 24 to the output gear 58 may be, for example, about 0.442:1, though gear reduction ratio provided by the combination of the input gear, the output gear and the idler gear 60 can be any other desired gear reduction ratio. Although the input gear 24 has been shown and described as being indirectly connected to the output gear 58 (and, accordingly, the intermediate shaft 56) via one idler gear 60, the input gear may be indirectly connected to the output gear via multiple idler gears or directly connected to the output gear (e.g., in a no idler gear configuration).

The intermediate shaft 56 is operatively connected to the output shaft 34. Therefore, rotation of the steering wheel 22 transmits torque to the output shaft 34 through at least the input shaft 14, the input gear 24, the idler gear 60 and the intermediate shaft 56. The output shaft 34 thus may rotate or be urged to rotate under the influence of torque originating from the steering wheel 22. In this steering system configuration, there is a mechanical connection between the steering wheel 22 and the intermediate shaft 56 and, accordingly, between the steering wheel and the steerable vehicle wheels 12. The steering system 10, however, may be manipulated into a steer-by-wire steering system (i.e., a steering system in which there is no mechanical connection between the steering wheel 22 and the steerable vehicle wheels 12) by removing the mechanical connection between the steering wheel 22 and the intermediate shaft 56. In the steer-by-wire configuration of the steering system 10, the steerable vehicle wheels 12 may be steered via torque originating only from electric motor 36.

Returning to FIG. 2, the steering system 10 further includes a controller 62 and one or more vehicle condition sensors 64 that cooperate to control the EPS unit 16 based on sensed vehicle conditions. In one example, the vehicle condition sensors 64 can include a torque sensor and/or a position sensor electrically connected to the controller 62. The torque sensor, when provided, senses the torque applied to the steering wheel 22 and generates a signal indicative of the torque. The position sensor, when provided, senses the rotational position of the steering wheel 22 and generates a signal indicative of the steering wheel position. It will be appreciated that the vehicle condition sensors 64 can be positioned inside the housing 40 (as is shown in FIG. 2) or outside the housing.

The signals from the vehicle condition sensors 64 are sent to the controller 62. The controller 62 analyzes the outputs of the vehicle condition sensors 64 and affects operation of the motor 36 as a function of the output of the sensors. It is also contemplated that only the torque measurements or only the steering wheel position measurements may be used to affect operation of the motor 36. The controller 62 can also have inputs that vary as a function of sensed lateral acceleration of the vehicle or other vehicle operating conditions. In any case, the signals received by the controller 62 dictate the speed and/or torque of the motor 36 and thereby dictate the speed and torque transferred by an output shaft 66 of the motor to the gearbox 38 to assist in the turning of (when the steering wheel 22 is mechanically connected to the steerable vehicle wheels 12) or to turn (in the steer-by-wire configuration) the steerable vehicle wheels 12.

As shown in FIGS. 2-4, the output shaft 66 extends along a fourth rotational axis A4 into the gearbox 38 and toward a first planetary gear stage 68. The fourth rotational axis A4 is coaxial with the third rotational axis A3, though the output shaft 66 may be configured such that the fourth rotational axis A4 is noncoaxial with the third rotational axis A3. The first planetary gear stage 68 includes a sun gear 70 secured to the output shaft 66 and rotatable therewith. The sun gear 70 is formed integrally with the output shaft 66 as a single monolithic piece, though the sun gear may be formed separately from and subsequently attached to the output shaft. Planetary gears 72 are in meshed engagement with the sun gear 70 and with a ring gear 74 that is rotationally fixed in the housing 40. Rotating the output shaft 66 and secured sun gear 70 about the third rotational axis A3 responsively rotates or urges the planetary gears 72 to rotate and orbit the sun gear (and, accordingly, the third rotational axis) while maintaining their meshed engagement with the ring gear 74. Although three planetary gears 72 are shown, the first planetary gear stage 68 can include any number of planetary gears.

The planetary gears 72 are rotatably supported on a carrier 76 that rotates about the third rotational axis A3 as the planetary gears rotate and orbit the sun gear 68. The carrier 76 is radially spaced from the housing 40 and radially positioned between the sun gear 70 and the ring gear 74. The first planetary gear stage 68 can have a gear reduction ratio from the sun gear 70 to the carrier 76 of, for example, about 9:1, though the first planetary gear stage can have any desired gear reduction ratio.

The first planetary gear stage 68 is operably connected to a second planetary gear stage 78 within the housing 40. However, the first and second planetary gear stages 68, 78 are not directly connected to one another. Instead, the first planetary gear stage 68 is operably connected in series with the second planetary gear stage 79 via the intermediate shaft 56. The intermediate shaft 56 thus transfers torque from the first planetary gear stage 68 to the second planetary gear stage 78. In other words, the intermediate shaft 56 functions as an intermediary for transferring rotation of the first planetary gear stage 68 to the second planetary gear stage 78.

As shown in FIGS. 2-4, a first end 80 of the intermediate shaft 56 is rotationally fixed to the carrier 76. In particular, the first end 80 may extends into an opening 82 of the carrier 76 where the first end engages with the carrier in a rotationally fixed manner. The intermediate shaft 56 thus is rotatable with the carrier 76 about the third rotational axis A3.

The second planetary gear stage 78 includes a sun gear 84 secured to the second end 82 of the intermediate shaft 56 and rotatable therewith. The sun gear 84 is formed integrally with the second end 82 as a single monolithic piece, though the sun gear may be formed separately from and subsequently attached to the intermediate shaft 56. The sun gear 84 thus is rotatable with the carrier 76 about the third rotational axis A3. Planetary gears 86 are in meshed engagement with the sun gear 84 and with a ring gear 88 that is rotationally fixed in the housing 40.

Rotating the sun gear 84 about the third rotational axis A3 responsively rotates or urges the planetary gears 86 to rotate and orbit the sun gear (and, accordingly, the third rotational axis) while maintaining their meshed engagement with the ring gear 88. Although three planetary gears 86 are shown, the second planetary gear stage 78 can include any number of planetary gears.

The planetary gears 86 are rotatably supported on a carrier 90 that rotates about the third rotational axis A3 as the planetary gears rotate and orbit the sun gear 84. The carrier 90 is radially spaced from the housing 40 and radially positioned between the sun gear 84 and the ring gear 88. The second planetary gear stage 78 can have a gear reduction ratio from the sun gear 84 to the carrier 90 of, for example, about 5.538:1, though the second planetary gear stage can have any desired gear reduction ratio.

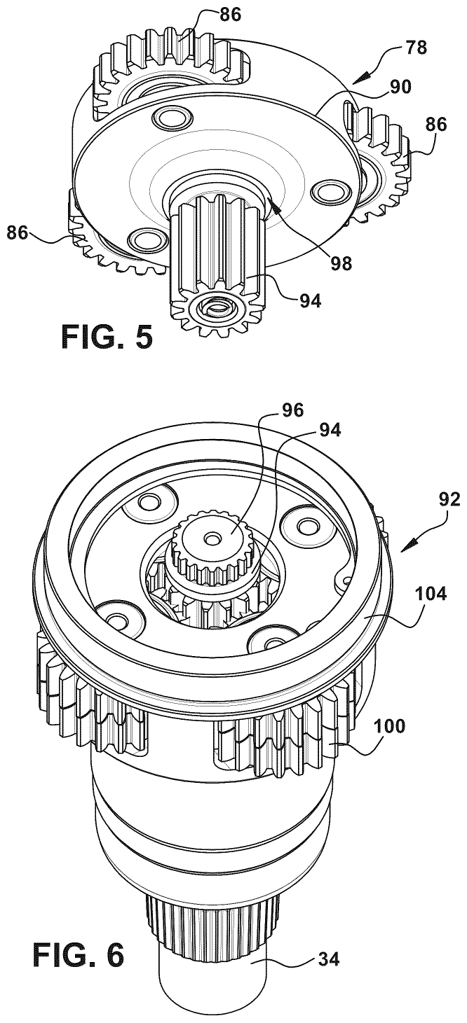

Referring to FIGS. 2-6 the second planetary gear stage 78 is operably connected (e.g., directly connected) to a third planetary gear stage 92 within the housing 40. The second third gear stage 92 includes a sun gear 94 secured to the carrier 90 of the second planetary gear stage 78. In particular, the sun gear 94 may include an end 96 that extends into an opening 98 of the carrier 90 where the first end engages with the carrier in a rotationally fixed manner. The sun gear 94 thus is rotatable with the carrier 90 about the third rotational axis A3. Planetary gears 100 are in meshed engagement with the sun gear 94 and with a ring gear 102 that is rotationally fixed in the housing 40.

Rotating the sun gear 94 about the third rotational axis A3 responsively rotates or urges the planetary gears 100 to rotate and orbit the sun gear (and, accordingly, the third rotational axis) while maintaining their meshed engagement with the ring gear 102. Although six planetary gears 100 are shown, the third planetary gear stage 92 can include any number of planetary gears.

The planetary gears 100 are rotatably supported on a carrier 104 that rotates about the third rotational axis A3 as the planetary gears rotate and orbit the sun gear 94. The carrier 104 is radially spaced from the housing 40 and radially positioned between the sun gear 94 and the ring gear 102. The third planetary gear stage 92 can have a gear reduction ratio from the sun gear 94 to the carrier 102 of, for example, about 5.538:1, though the third planetary gear stage can have any desired gear reduction ratio. It will be appreciated that the gearbox 38 can include additional planetary gear stages (not shown) to achieve a desired gear reduction ratio through the gearbox.

The output shaft 34 is formed integrally with the carrier 104 as a single monolithic piece, though the output shaft may be formed separately from and subsequently rotationally fixed to the carrier (e.g., via bolting or welding). Therefore, the output shaft 34 is connected directly to the carrier 104 such that the carrier and the output shaft rotate together about the third rotational axis A3 relative to the housing 40. The output shaft 34 extends out from the housing 40 and includes splines 158 outside the housing for direct connection to the pitman arm 28.

In an example operation of the steering system 10 in which the steering wheel 22 is mechanically connected to the steerable vehicle wheels 12, the operator rotates the steering wheel 22 to thereby urge the input gear 24 to rotate about the first rotational axis A1. The rotating input gear 24 urges the idler gear 60 to rotate about the second rotational axis A2, which responsively urges the output gear 58 (and, accordingly, the intermediate shaft 56) to rotate about the fourth rotational axis A4. This, in turn, urges the output gear 24 (and, accordingly, the intermediate shaft 56) to rotate about the third rotational axis A3. At the same time, the controller 62, in response to signals received from the vehicle condition sensor(s) 64, actuates the motor 36 to rotate the output shaft 66 about the fourth rotational axis A4, which urges the carrier 76 to rotate about the third rotational axis via the sun gear 70 and the planetary gears 72. As a result, the intermediate shaft fixed to the carrier 76 is also urged to rotate about the third rotational axis A3. Therefore, the intermediate shaft 56 is urged to rotate about the third axis A3 via torque from each of the steering wheel 22 and the output shaft 66 of the motor 36. The intermediate shaft 56 also operatively and mechanically functions as a junction at which torque originating from each of the steering wheel 22 and the motor 36 coalesce into a single torque.

The sun gear 84 of the second planetary gear stage 92, being rotationally fixed to the intermediate shaft 56, rotates with the intermediate shaft about the third rotational axis A3. The sun gear 84 urges the carrier 90 to rotate about the third rotational axis A3 via the planetary gears 86.

The sun gear 94 of the third planetary gear stage 92, being rotationally fixed to the carrier 90, rotates with the carrier about the third rotational axis A3. The sun gear 94 urges the carrier 104 (and, thus, the attached output shaft 34) to rotate about the third rotational axis A3 via the planetary gears 100.

As shown in FIG. 1, when the output shaft 34 rotates about the third rotational axis A3, the pitman arm 28 secured thereto is likewise urged to rotate about the third rotational axis A3. Therefore, pitman arm 28 is connected directly to the output shaft 34 such that torque from the output shaft directly urges the pitman arm to rotate about the third rotational axis. Rotation of the pitman arm 28 affects steering of the steerable vehicle wheels 12 via the steering linkage 26 (e.g., via the drag link 30 and tie rod 32).

Therefore, the steering system 10 may include a first force flow in which torque originating from the electric motor 36 flows to the pitman arm 28 through the first planetary gear stage 68, the intermediate shaft 56, the second planetary gear stage 78, the third planetary gear stage 92 and the output shaft 34. A total gear reduction ratio of the first force flow (i.e., the total output shaft 66 to output shaft 34 or pitman arm 28 gear reduction ratio) may be, for example, about 276:1 (9*5.538*5.538), though the total gear reduction ratio of the first flow may be configured to have any desired total gear reduction ratio.

A second force flow of the steering system 10 includes the torque that originates from the steering wheel 22 and flows to the pitman arm 28 through the input gear 24, the idler gear 60, the output gear 58 and fixed intermediate shaft 56, the second planetary gear stage 78, the third planetary gear stage 92 and the output shaft 34. A total gear reduction ratio of the second force flow (i.e., the total steering wheel 22 to output shaft 34 or pitman arm 28 gear reduction ratio) may be, for example, about 13.55:1 (0.442*5.538*5.538), though the total gear reduction ratio of the second flow may be configured to have any desired total gear reduction ratio.

It should be appreciated that each of the first and second force flows is entirely torque-based with no torque-to-linear force transitions and no linear force-to-torque transitions. In other words, every feature that is moved/rotated or urged to move/rotate via another feature is done so via torque, not a linear force(s). Generally, each torque-to-linear force conversion and linear force-to-torque conversion in a steering system at least partially reduces system efficiency. Therefore, by omitting any of such conversions/transitions, the steering system 10 of FIGS. 1-6 is more efficient than those that include such conversions/transitions.

It should also be appreciated that the output shaft 66, the first, second, and third planetary gear stages 68, 78, 92, the intermediate shaft 56 and the output shaft 34 are aligned on the same rotational axis A3/A4. This alignment helps balance forces within the EPS unit 16 and/or the steering system 10, leading to improved system efficiency. The output shaft 34 and the pitman arm 28 being directly connected to one another and rotatable about the same axis also helps improve system efficiency as losses that would have otherwise occurred as a result of an indirect or more complex connection between the output shaft and the pitman arm are prevented.

While the above alignments/arrangements provide at least the noted system benefits, changes may be made to the geometry of steering system 10 in order to accommodate certain spacing constraints within the vehicle without an overly significant drop off in system efficiency.

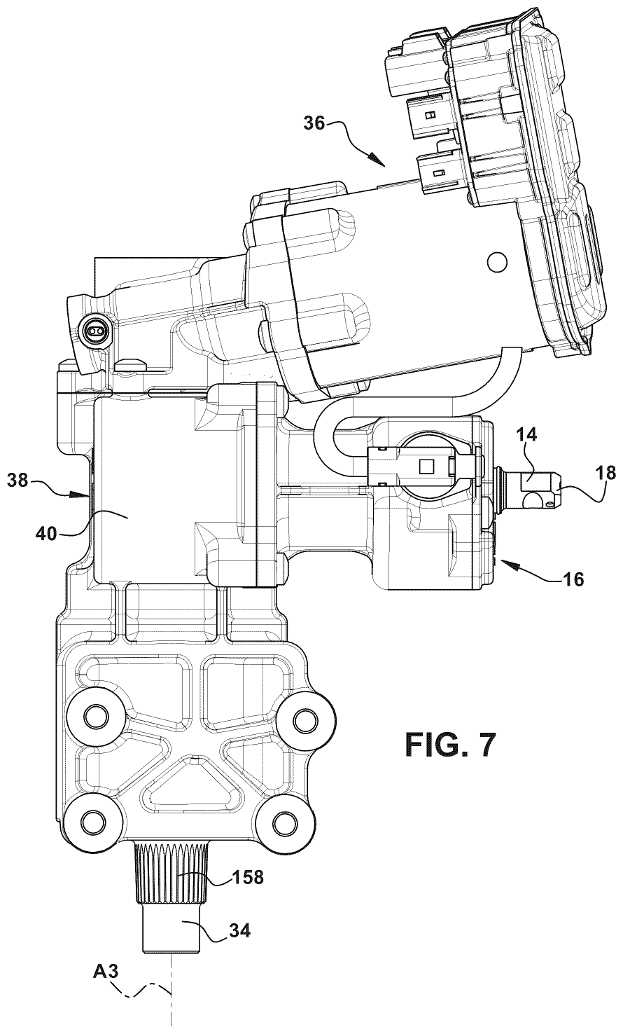

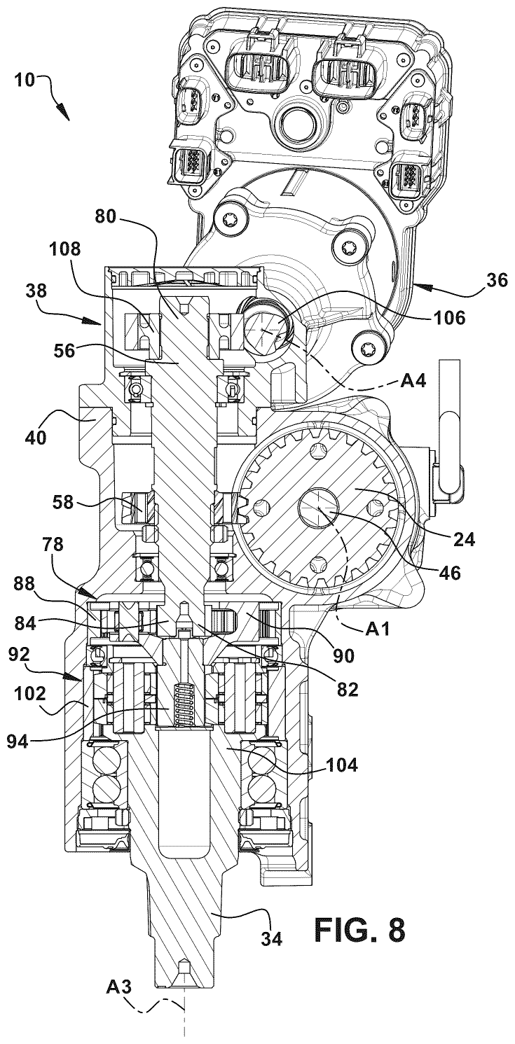

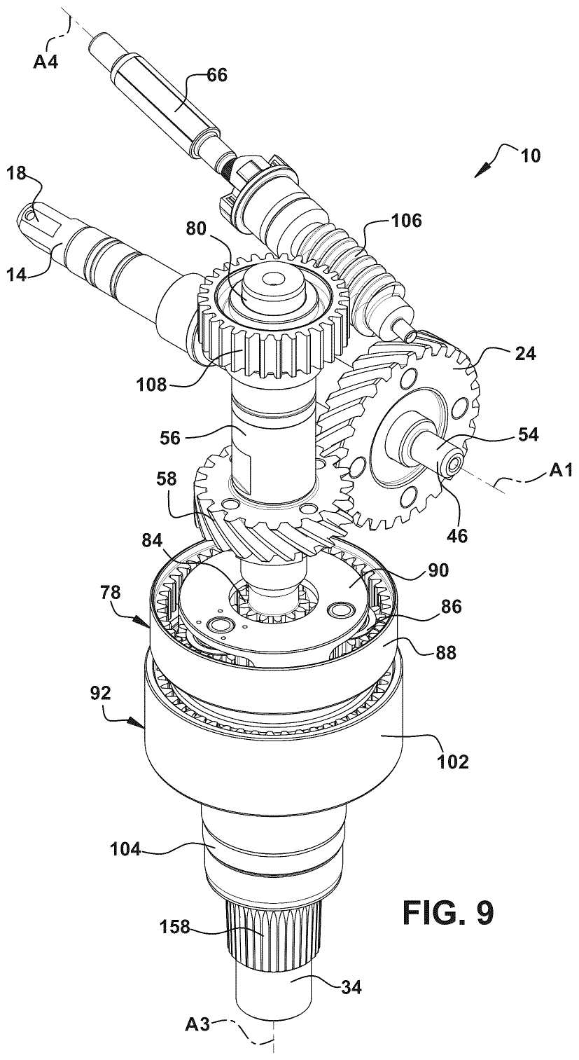

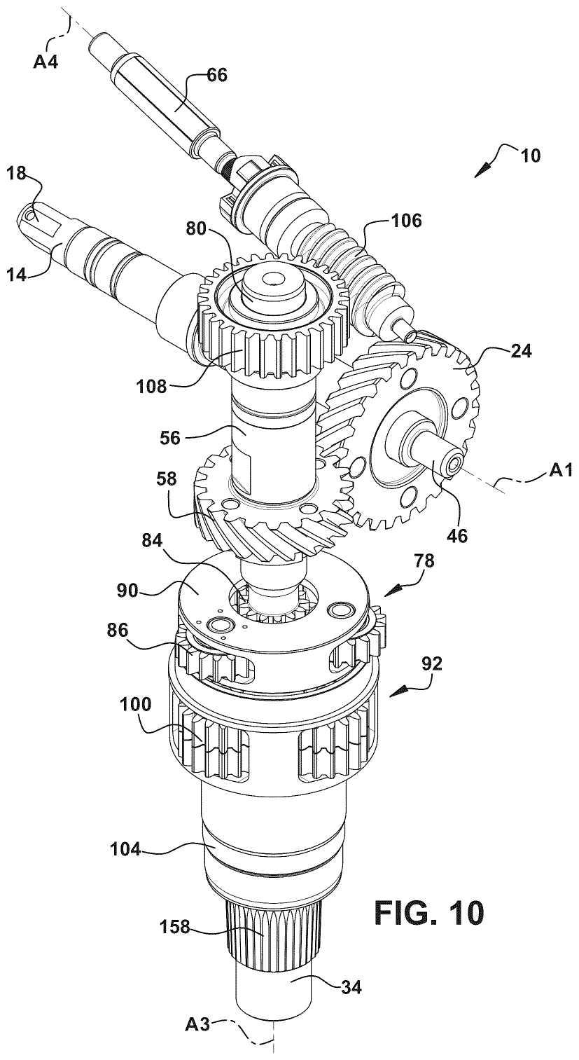

For example, as shown in FIGS. 7-10, the steering system 10 may be configured such that the output shaft 66 of the motor 36 is noncoaxial with the output shaft 34 and the first planetary gear stage 68 is omitted. In this configuration, the output shaft 66 extends along the fourth rotational axis A4 and is operatively connected to a worm shaft 106 such that rotation of the output shaft 66 about the fourth rotational axis responsively urges or causes the worm shaft to rotate about the fourth rotational axis. The worm shaft 106 is meshingly engaged to a worm wheel 108 such that rotation of the pinion responsively rotates or urges the worm wheel to rotate relative to the housing 40. The worm wheel 108 is rotationally fixed to the intermediate shaft 56 (e.g., to the first end 80). Therefore, rotation of the output shaft 66 transmits torque to the intermediate shaft 56 through the worm shaft 106 and the worm wheel 108.

The worm wheel 108 is arranged on the intermediate shaft 56 such that they rotate together about the third rotational axis A3. Unlike in the configuration of FIGS. 1-6, the third rotational axis A3 and the fourth rotational axis A4 of FIGS. 7-10 are not coaxial. Instead, the fourth rotational axis A4 is nonparallel to and radially offset from the third rotational axis A3. Furthermore, although the fourth rotational axis A4 is shown as extending transversely, but not perpendicularly, relative to third rotational axis A3, the steering system of FIGS. 1-7 may be configured such that the fourth rotational axis extends perpendicularly to the third rotational axis.

A gear reduction ratio from the worm shaft 106 to the worm wheel 108 may be, for example, about 15:1, though gear reduction ratio provided between the worm shaft and worm wheel can be any other desired gear reduction ratio.

Similarly to the system 10 of FIGS. 1-6, the intermediate shaft 56 of FIGS. 7-10 may also be driven via torque from the steering wheel 22 when there is a mechanical connection between the steering wheel 22 and the steerable vehicle wheels 12. The first rotational axis A1 about which the input gear 24 rotates with the output shaft 46, however, is not parallel to the third rotational axis A3. Instead, the first rotational axis A1 extends transversely (e.g., perpendicularly) to the third rotational axis A3. Furthermore, the steering system of FIGS. 7-10, does not include the idler gear 60. Therefore, the input gear 24 is directly meshingly engaged to the output gear 58. The output gear 58 is separate from and secured to the intermediate shaft 56 in this steering system 10 configuration, though it may be formed integrally with the intermediate shaft as a single monolithic piece.

Each of the input gear 24 and the output gear 58 of FIGS. 7-10 may be a screw gear in order to accommodate their transverse rotational axis relationship, though the input and output gear may be any other desired gear. A gear reduction ratio from the input gear 24 to the output gear 58 may be, for example, about 0.77:1, though gear reduction ratio provided between the input and output gears can be any other desired gear reduction ratio.

Although the steering system 10 of FIGS. 7-10 does not include the first planetary gear stage 68, the steering system 10 still includes the second and third planetary gear stages 78, 92. The second and third planetary gear stages 78, 92 can each have a gear reduction ratio of, for example, about 4.615:1, though the second and third planetary gear stages can have any desired gear reduction ratio. It will be appreciated that the gearbox 38 of FIGS. 7-10 can include additional planetary gear stages (not shown) to achieve a desired gear reduction ratio through the gearbox.

Similarly to the steering system 10 of FIGS. 1-6, torque from the output shaft 66 of the motor 36 and/or the steering wheel 22 of FIGS. 7-10 urges the intermediate shaft 56 to rotate about the third axis A3. The rotating intermediate shaft 56 drives the second planetary gear stage 78 via the sun gear 84, which in turn drives the third planetary gear stage 92. Rotation of the sun gear 94 of the third planetary gear stage 92 urges the carrier 104 (and, thus, the attached output shaft 34) to rotate about the third rotational axis A3 via the planetary gears 100. The output shaft 34 of the steering system 10 of FIGS. 7-10 is also configured to be directly attached and rotationally fixed to the pitman such that the pitman arm is urged to rotate about the third rotational axis A3 with the output shaft.

The steering system 10 of FIGS. 7-10 may include a first force flow in which torque originating from the electric motor 36 flows to the pitman arm 28 through the intermediate shaft 56, the second planetary gear stage 78, the third planetary gear stage 92 and the output shaft 34. A total gear reduction ratio of the first force flow (i.e., the total output shaft 66 to output shaft 34 or pitman arm 28 gear reduction ratio) may be, for example, about 319:1 (15*4.615*4.615), though the total gear reduction ratio of the first flow may be configured to have any desired total gear reduction ratio.

A second force flow of the steering system 10 includes the torque that originates from the steering wheel 22 and flows to the pitman arm 28 through the input gear 24, the output gear 58 and fixed intermediate shaft 56, the second planetary gear stage 78, the third planetary gear stage 92 and the output shaft 34. A total gear reduction ratio of the second force flow (i.e., the total steering wheel 22 to output shaft 34 or pitman arm 28 gear reduction ratio) may be, for example, about 16.4:1 (0.77*4.615*4.615), though the total gear reduction ratio of the second flow may be configured to have any desired total gear reduction ratio.

It should be appreciated that each of the first and second force flows of the system of FIGS. 7-10 is entirely torque-based with no torque-to-linear force transitions. It should also be appreciated that the worm wheel 108, the intermediate shaft 56, the second and third planetary gear stages 68, 78, 92 and the output shaft 34 are aligned on the same rotational axis A3. This alignment helps balance forces within the EPS unit 16 and/or the steering system 10, leading to improved system efficiency.

What have been described above are examples of the present invention. It is, of course, not possible to describe every conceivable combination of components or methodologies for purposes of describing the present invention, but one of ordinary skill in the art will recognize that many further combinations and permutations of the present invention are possible. Accordingly, the present invention is intended to embrace all such alterations, modifications and variations that fall within the spirit and scope of the appended claims.

Having described the invention, the following is claimed:

1. A steering system for use in turning steerable vehicle wheels, the steering system comprising:
an electric motor having a motor output shaft rotatable about a first axis;
a first planetary gear stage drivable via torque from the motor output shaft;
a second planetary gear stage drivable via torque from the first planetary gear stage;
an output shaft connected directly to the second planetary gear stage such that torque from the second planetary gear stage directly urges the output shaft to rotate about a second axis, the second axis being coaxial with or nonparallel to the first axis; and
a pitman arm directly connected to the output shaft such that torque from the output shaft directly urges the pitman arm to rotate about the second axis, the pitman arm being connected to the steerable vehicle wheels via a steering linkage such that rotation of the pitman arm affects steering of the steerable vehicle wheels.

2. The steering system of claim 1, wherein the first planetary gear stage has a first sun gear, first planetary gears meshed with the first sun gear, and a first carrier connected to the first planetary gears, the first sun gear being connected to the motor output shaft such that the torque from the motor output shaft urges the first sun gear to rotate about the second axis, rotation of the first sun gear urging the first planetary gears to rotate and orbit the first sun gear, the first carrier being urged to rotate about the second axis in response to the first planetary gears rotating and orbiting the first sun gear.

3. The steering system of claim 2, wherein the motor output shaft is connected to the first sun gear such that torque from the motor output shaft urges the first sun gear to rotate about the second axis, the first and second axes being coaxial.

4. The steering system of claim 2, wherein the motor output shaft is connected to the first sun gear such that torque from the motor output shaft urges the first sun gear to rotate about the second axis, the second axis being nonparallel to the first axis.

5. The steering system of claim 4, further comprising an intermediate shaft connected to the motor output shaft and a steering wheel such that torque from each of the motor output shaft and the steering wheel urges the intermediate shaft to rotate about the second axis, the intermediate shaft further being connected to the first sun gear such that torque from the intermediate shaft urges the first sun gear to rotate about the second axis.

6. The steering system of claim 5, wherein the first sun gear is integrally formed with the intermediate shaft as a single monolithic piece.

7. The steering system of claim 2, wherein the second planetary gear stage has a second sun gear, second planetary gears meshed with the second sun gear, and a second carrier connected to the second planetary gears, the second sun gear being connected to the first carrier such that torque from the first carrier urges the second sun gear to rotate about the second axis, rotation of the second sun gear urging the second planetary gears to rotate and orbit the second sun gear, the second carrier being urged to rotate about the second axis in response to the second planetary gears rotating and orbiting the second sun gear, the output shaft being connected directly to the second carrier such that torque from the second carrier urges the output shaft to rotate about the second axis.

8. The steering system of claim 7, wherein the output shaft is integrally formed with the second carrier as a single monolithic piece.

9. The steering system of claim 7, further comprising a third planetary gear stage, the third planetary gear stage having a third sun gear, third planetary gears meshed with the third sun gear, and a third carrier connected to the third planetary gears, the third sun gear being connected to the first carrier such that torque from the first carrier urges the third sun gear to rotate about the second axis, rotation of the third sun gear urging the third planetary gears to rotate and orbit the third sun gear, the third carrier being urged to rotate about the second axis in response to the third planetary gears rotating and orbiting the third sun gear, the third carrier being connected to the second sun gear such that torque from the third carrier urges the second sun gear to rotate about the second axis.

10. The steering system of claim 9, further comprising an intermediate shaft connected to the first carrier and a steering wheel such that torque from each of the first carrier and the steering wheel urges the intermediate shaft to rotate about the second axis, the intermediate shaft further being connected to the second sun gear such that torque from the intermediate shaft urges the second sun gear to rotate about the second axis.

11. The steering system of claim 10, wherein the second sun gear is integrally formed with the intermediate shaft as a single monolithic piece.

12. The steering system of claim 1, further comprising an intermediate shaft operatively between the first and second planetary gear stages, the intermediate shaft being connected to the first planetary gear stage and a steering wheel such that torque from each of the first planetary gear stage and the steering wheel urges the intermediate shaft to rotate about the second axis, the intermediate shaft further being connected to the second planetary gear stage such that torque from the intermediate shaft drives the second planetary gear stage.

13. The steering system of claim 12, wherein the steering system is manipulable into a steer-by-wire steering system via the removal of a mechanical connection between the steering wheel and the intermediate shaft.

14. The steering system of claim 1, further comprising an intermediate shaft operatively between the motor output shaft and the first planetary gear stage, the intermediate shaft being connected to the motor output shaft and a steering wheel such that torque from each of the motor output shaft and the steering wheel urges the intermediate shaft to rotate about the second axis, the intermediate shaft further being connected to the first planetary gear stage such that torque from the intermediate shaft drives the first planetary gear stage.

15. The steering system of claim 14, wherein the steering system is manipulable into a steer-by-wire steering system via the removal of a mechanical connection between the steering wheel and the intermediate shaft.

16. The steering system of claim 1, wherein a force flow from the electric motor to the pitman arm is entirely torque-based with no torque-to-linear force transitions and no linear force-to-torque transitions.

17. The steering system of claim 1, wherein the output shaft is further connected to a steering wheel such that torque from the steering wheel also urges the output shaft to rotate about the second axis, a force flow from each of the electric motor and the steering wheel to the pitman arm is entirely torque-based with no torque-to-linear force transitions and no linear force-to-torque transitions.

18. A steering system for use in turning steerable vehicle wheels, the steering system comprising:
a steering wheel;
an electric motor;
an intermediate shaft connected to the motor output shaft and the steering wheel such that torque from each of the motor output shaft and the steering wheel urges the intermediate shaft to rotate about an axis;
a first planetary gear stage drivable via torque from the intermediate shaft;
a second planetary gear stage drivable via torque from the first planetary gear stage;
an output shaft connected directly to the second planetary gear stage such that torque from the second planetary gear stage directly urges the output shaft to rotate about the axis; and
a pitman arm directly connected to the output shaft such that torque from the output shaft directly urges the pitman arm to rotate about the axis, the pitman arm being connected to the steerable vehicle wheels via a steering linkage such that rotation of the pitman arm affects steering of the steerable vehicle wheels.

19. The steering system of claim 18, wherein a force flow from each of the electric motor and the steering wheel to the pitman arm is entirely torque-based with no torque-to-linear force transitions and no linear force-to-torque transitions.

20. The steering system of claim 18, wherein the steering system is manipulable into a steer-by-wire steering system via the removal of a mechanical connection between the steering wheel and the intermediate shaft.
